(19) United States
(12) Patent Application Publication
(10) Pub. No.: US 2016/0300284 A1
(43) Pub. Date: Oct. 13, 2016

(54) METHOD AND APPARATUS FOR PROVIDING A CUSTOMIZED MERCHANT PRODUCT

(71) Applicant: Derek Webster, New York, NY (US)

(72) Inventor: Derek Webster, New York, NY (US)

(21) Appl. No.: 15/092,703

(22) Filed: Apr. 7, 2016

Related U.S. Application Data
(60) Provisional application No. 62/144,090, filed on Apr. 7, 2015.

(51) Int. Cl. G06Q 30/06; H04W 12/06

(52) U.S. Cl. CPC G06Q 30/0621; H04W 12/06

(57) ABSTRACT

A method and apparatus for providing a merchant product includes receiving a first transmission from a first device by a server. The first transmission includes information relating to authentication data for authenticating a second device for which to provide the merchant product. The authentication data is stored in a database of the server. The server receives a second transmission from the second device that includes data for authenticating the second device. The information in the second transmission is compared to the authentication data stored in the database of the server to determine whether or not the second device is authenticated, and if the second device is authenticated, the server customizes the merchant product based upon the authentication data stored in the database of the server. The server transmits the customized merchant product to the second device.

### CROSS REFERENCE TO RELATED APPLICATIONS

This Application claims the benefit of U.S. Provisional Application Ser. No. 62/144,090, filed Apr. 7, 2015, the contents of which are incorporated herein as if fully set forth.

### FIELD OF INVENTION

The present disclosure relates to virtual payment systems, and in particular to a method and apparatus for providing a customized merchant product.

### BACKGROUND

The rise of “popup” merchants in malls, at festivals, and at other functions has given rise to a need to provide payment solutions. In the past, one might have been required to pay only in cash at these merchants. However, with the advent of electronic devices that have significant functionality and connectability, a smartphone, tablet, or other device, can be equipped to take credit card payments conveniently. Mobile merchants, therefore, utilize a reseller, who provides them with an application to accept swiped credit card payments that are processed by a credit card processor.

Accordingly, it would be beneficial to provide a method and apparatus for a reseller to provide to a merchant, (e.g., a mobile merchant), an application to accept swiped credit card payments.

### SUMMARY

A method for providing a merchant product is disclosed. The method includes receiving a first transmission from a first device by a server. The first transmission includes information relating to authentication data for authenticating a second device for which to provide the merchant product. The authentication data is stored in a database of the server. The server receives a second transmission from the second device that includes data for authenticating the second device. The information in the second transmission is compared to the authentication data stored in the database of the server to determine whether or not the second device is authenticated, and if the second device is authenticated, the server customizes the merchant product based upon the authentication data stored in the database of the server. The server transmits the customized merchant product to the second device.

An apparatus for providing a merchant product is disclosed. The apparatus includes a processor, an input/output (I/O) driver, and a memory. The processor is configured to receive a first transmission from a first device from the I/O driver via the Internet that includes information relating to authentication data for authenticating a second device for which to provide the merchant product. The processor stores the authentication data in the memory. The processor receives a second transmission from the second device from the I/O driver via the Internet that includes data for authenticating the second device. The processor compares the information in the second transmission to the authentication data stored in the memory to determine whether or not the second device is authenticated, and if the second device is authenticated, customizes the merchant product based upon the authentication data stored. The processor transmits the customized merchant product via the Internet to the second device through the I/O device.

A system for providing a merchant product is disclosed. The system includes a first device in communication with the Internet configured to transmit a first transmission via the Internet including information relating to authentication data for authenticating a second device for which to provide a merchant product. The system also includes a second device in communication with the Internet configured to transmit a second transmission via the Internet including an authentication request to receive the merchant product, the authentication request including data for authenticating the second device. The system further includes a server in communication with the Internet configured to receive the first transmission and the second transmission via the Internet, and configured to store the authentication data, compare the information in the second transmission to the authentication data stored to determine whether or not the second device is authenticated, if the second device is authenticated, customize the merchant product based upon the authentication data stored, and transmit the customized merchant product via the Internet to the second device.

### BRIEF DESCRIPTION OF THE DRAWINGS

FIG. 1 is a schematic diagram of an example system for providing merchant services;

FIG. 2 is a schematic block diagram of an example wireless device operating in the example system of FIG. 1;

FIG. 3 is a schematic block diagram of an example server operating in the example system of FIG. 1;

FIG. 4 is a flow diagram of an example method for providing a customized merchant product;

FIGS. 5A-5D show example screenshots of a mobile application on a merchant device;

FIGS. 6A-6B show example screenshots of a merchant portal; and

FIGS. 7A-7B show example screenshots of a reseller portal.

### DETAILED DESCRIPTION OF THE PREFERRED EMBODIMENTS

Although a more detailed description of the method and apparatus follows below, briefly a method and apparatus for providing merchant services is described that provides a customized product to a merchant.

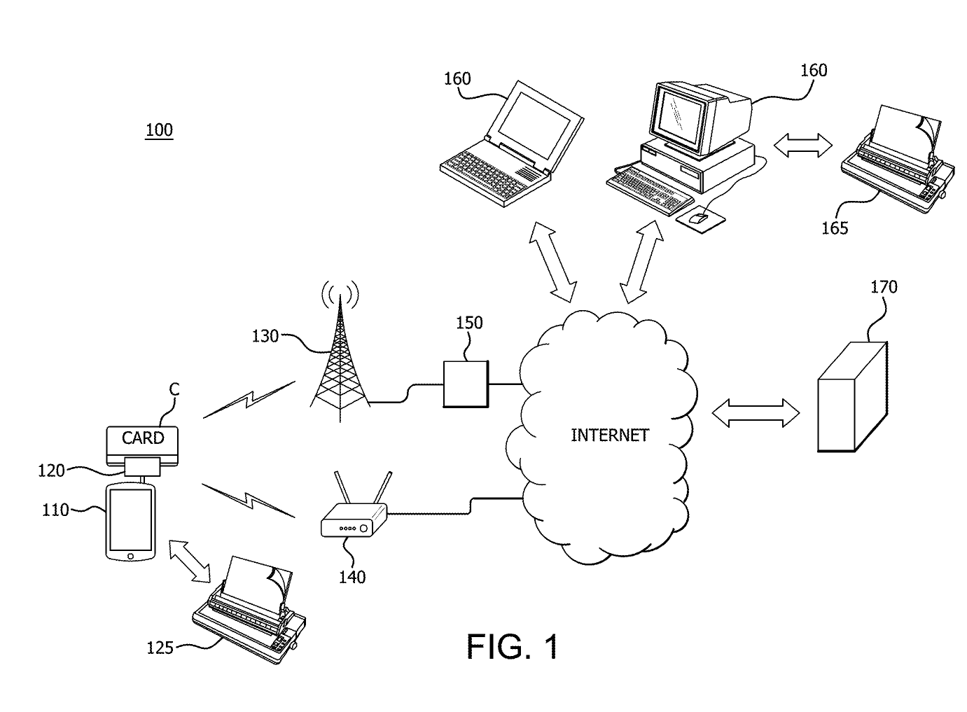

FIG. 1 is a schematic diagram of an example system 100 for providing merchant services. The system 100 includes a wireless device 110, including an electronic card reader 120 configured to read, for example, a credit/debit card C. The wireless device 110 may be in wireless communication with a cellular base station 130 and/or a wireless router 140 for connection to the Internet to transmit and receive data. Additionally, a printer 125 may be in communication with the wireless device 110 in order to receive printouts. The base station 130 may be connected to the Internet via a Core Network 150, (e.g., Radio Network Controller, Gateway, or the like), or any other connection scheme. Similarly, the wireless router 140 may be connected to the Internet via any connection. The system also includes one or more reseller devices 160 and a provider server 170, all of which are also connected to the Internet by any type of connection. A printer 165 may be in communication with the one or more reseller devices 160 in order to receive printouts.

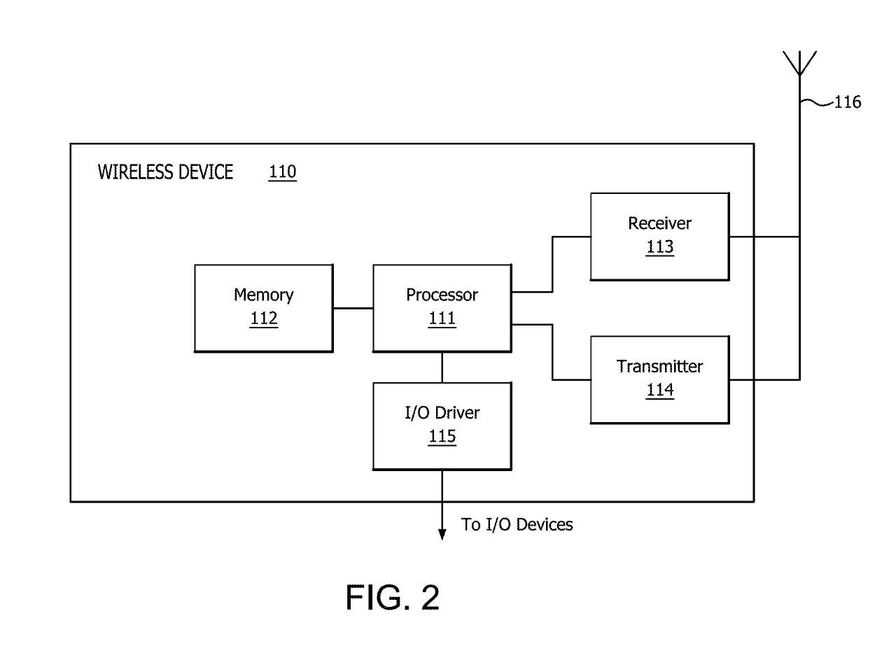

FIG. 2 is a schematic block diagram of an example wireless device 110 operating in the example system 100 of FIG. 1. The wireless device 110 includes a processor 111, a memory 112 in communication with the processor 111, a receiver 113 in communication with the processor 111, a transmitter 114 in communication with the processor 111, an Input/Output Device Driver (I/O driver) 115 in communication with the processor 111, and an antenna 116 in communication with the receiver 113 and the transmitter 114. The processor 111 is configured to receive data from the I/O driver 115, as well as to receive and send data to the memory 112. The processor is further configured to control receive data from the receiver 113 via the antenna 116, and to control the transmitter 114 to transmit data wireless via antenna 116. The I/O driver 115 is configured to be connected to, for example, the electronic card reader 120. The connection may include one or more of a USB port, audiojack connection, Bluetooth connection, or other connection.

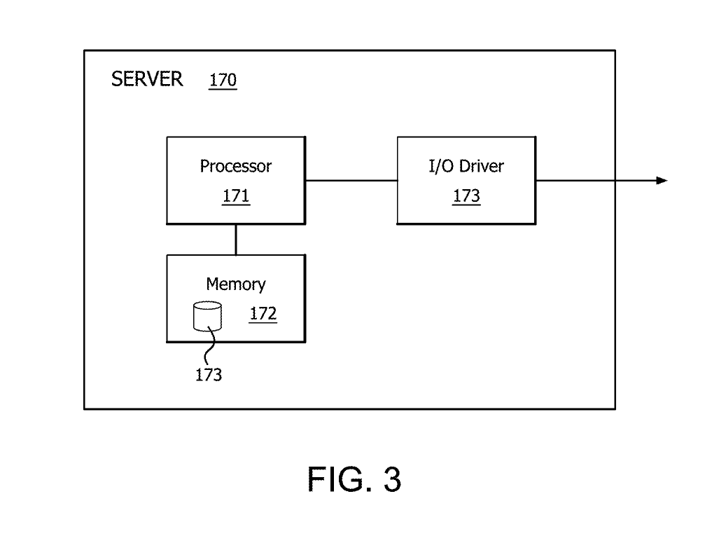

FIG. 3 is a schematic block diagram of an example server 170 operating in the example system 100 of FIG. 1. The sever 170 includes a processor 171, a memory 172 in communication with the processor 171, and an I/O driver 173 in communication with the processor. The memory 172 includes a database 173 for storing and extracting data. The I/O driver 173 transmits data to and receives data from the processor 171 for external transmission, (e.g., from and to the Internet). The server 170 may be utilized by a provider to provide merchant services via a reseller.

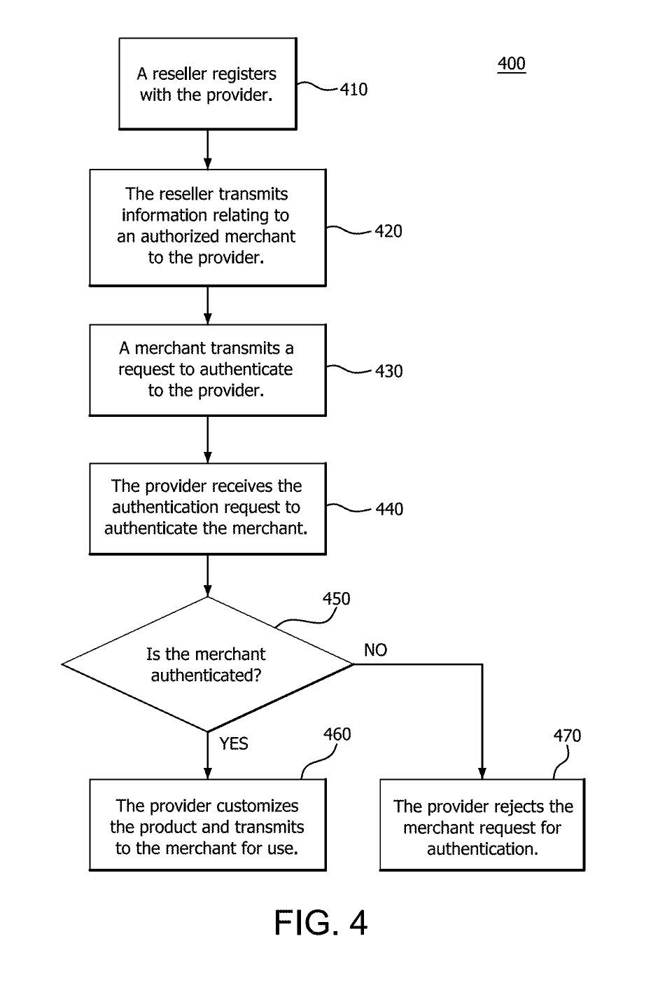

FIG. 4 is a flow diagram of an example method 400 for providing a customized merchant product. In step 410, a reseller registers with the provider. Accordingly, the provider is aware of that particular reseller and can provide a customized product.

Once registered, the reseller transmits information to the provider relating to an authorized merchant (step 420). For example, the reseller may provide information relating to authorized merchants who may access merchant services from the reseller to conduct transactions. This may be performed by the reseller by utilizing a reseller device 160, which may include a desktop computer, laptop computer, tablet, smartphone, or any device capable of connecting with the Internet. This information is transmitted by the reseller via the Internet to the server 170. The server 170 may receive the information via the I/O driver 173 which transmits the information to the processor 171 for processing and storage. The processor 171 stores the information in the database 173 of the memory 172.

In step 430, the merchant transmits a request to authenticate to the provider. For example, the merchant may utilize the wireless device 110, which may include a smartphone, a tablet, or the like, to connect to the Internet via the base station 130, (e.g., a cellular connection), or the router 140, (e.g., a WiFi connection). The processor 111 of the wireless device 110 may transmit the request via the transmitter 114 and the antenna 116.

The provider receives the authentication request to authenticate the merchant (step 440) via the Internet. For example, the I/O driver 173 receives the authentication request from the Internet and transmits it to the processor 171. The processor 171 extracts the information provided by the reseller in the database 173 of memory 172 to determine whether the merchant is authorized by the reseller. If the merchant is authenticated (step 450), then the provider customizes the product based on the reseller information and transmits the customized product to the merchant for use (460). If the merchant is not authenticated in step 450, then the provider rejects the merchant request for authentication (step 470).

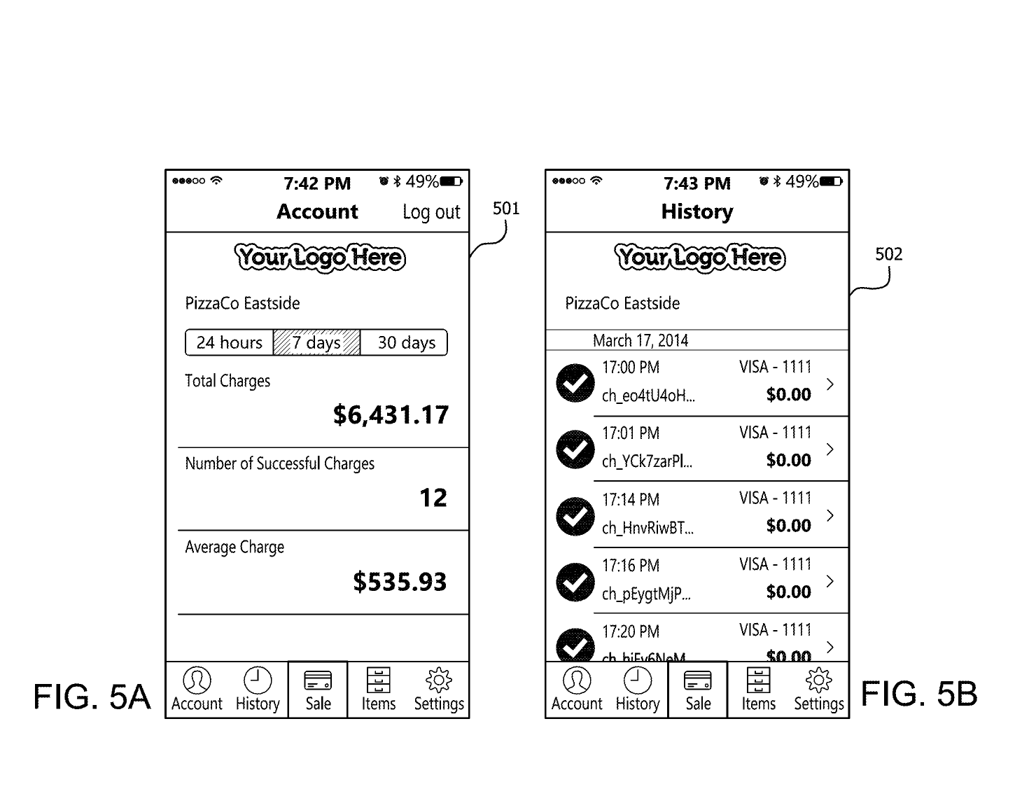

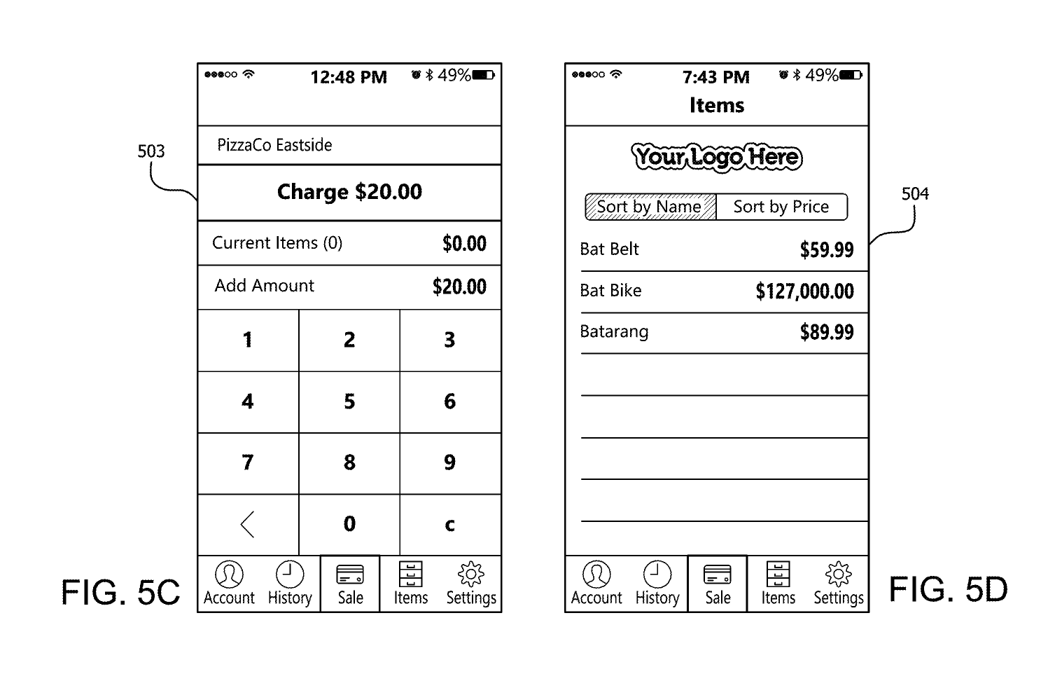

For example, if the merchant is authenticated in step 450, then the processor 171 utilizes the information stored in the database 173 of the memory 172 in order to customize the product for transmission to the merchant. The customized product is then transmitted to the merchant via the I/O driver 173 to the Internet and received by the antenna 116 and receiver 113 of the wireless device 110, where it is transferred to the processor 111, which may store the customized product in the memory 112. The customized product may be in the form of a customized mobile application that includes the reseller's logo, (e.g., cobrand), for use on the merchant's wireless device 110. In this regard, FIGS. 5A-5D show example screenshots of a customized mobile application on a merchant device, (e.g., wireless device 110). The screenshots depicted in FIGS. 5A-5D show an example merchant designated “PizzaCo Eastside”.

FIG. 5A shows an example screenshot 501 of the customized mobile application. The screenshot 501 includes a reseller's logo “Your Logo Here”, and may include additional customized information such as the total amount of charges over the last seven days, the number of successful charges/transactions, and the average amount of each charge. FIG. 5B shows an example screenshot 502 of the customized mobile application that shows the charges for a single day, along with the reseller's logo “Your Logo Here”.

FIG. 5C shows an example screenshot 503 of the customized mobile application during a transaction. That is, the merchant is shown entering an example charge for twenty dollars ($20.00) for processing by the customized application. This amount may be the subtotal, (e.g., with sales tax added but without an added tip for which a prompt may follow). FIG. 5D shows an example screenshot 504 of the customized mobile application that provides customized information relating to multiple sale items sold by the merchant and the amount of each items. For example, the unit price for each item may be depicted in FIG. 5D and the merchant may create a sale by adding one or more of the listed units or by entering an amount on a keypad. Again, in example screenshot 504 the customized application provided depicts the reseller logo “Your Logo Here”.

The customized mobile application for the merchant may also allow the merchant to perform additional functions. For example, the merchant may be able to automatically add sales tax, prompt for signature, and/or prompt for tip, based on selected and customizable preferences. As mentioned above, the wireless device 110 may include an electronic card reader 120 for receiving transactions via a credit card C. Accordingly, the processor 111 may utilize the customized mobile application to receive swiped credit card transactions, to receive keyed-in credit card numbers via the I/O driver 115 via a graphical user interface (GUI)/touchscreen of the wireless device. Additionally, the merchant may utilize the customized mobile application to record cash sales, and to cause the processor 111 to transmit e-receipts/SMS texts to customers via the transmitter 114 and antenna 116. The customized mobile application may further provide the ability to void transactions and to transmit refund transactions.

The customized mobile merchant application may provide support for multiple employee logins and/or multiple merchant accounts with one login. For example, a merchant may transmit information to the server 170 to provide authentication information for multiple merchant accounts, such that multiple employees may authenticate with the server 170 to receive a customized product. The merchant may also be able to synchronize the customized product with inventory, such that a most recent representation of inventory is presented via the customized mobile application. The inventory and employee information may be stored in the database 173 of the server 170 to enable access from any merchant device 110 and the ability to synchronize the information across any merchant device 110.

It should also be noted that the customized mobile application may be able to perform transactions when offline, (e.g., when there is no internet service), and then transmit the information once online. In addition to receiving the customized mobile application, the merchant may also receive the customized product from the provider as a customized merchant portal that can be accessed via a computer connected to the Internet.

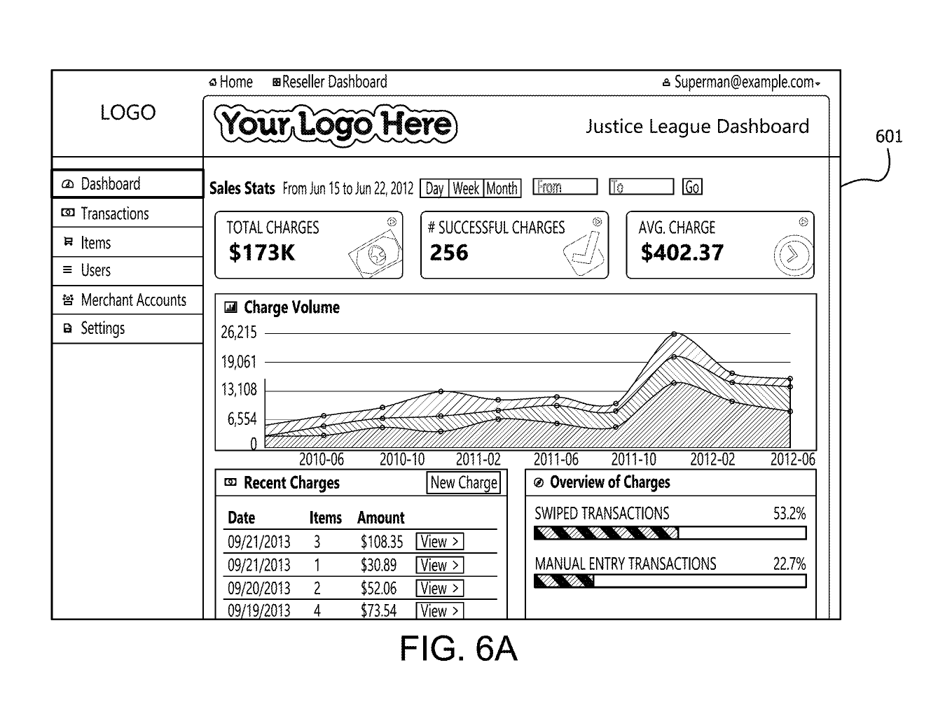

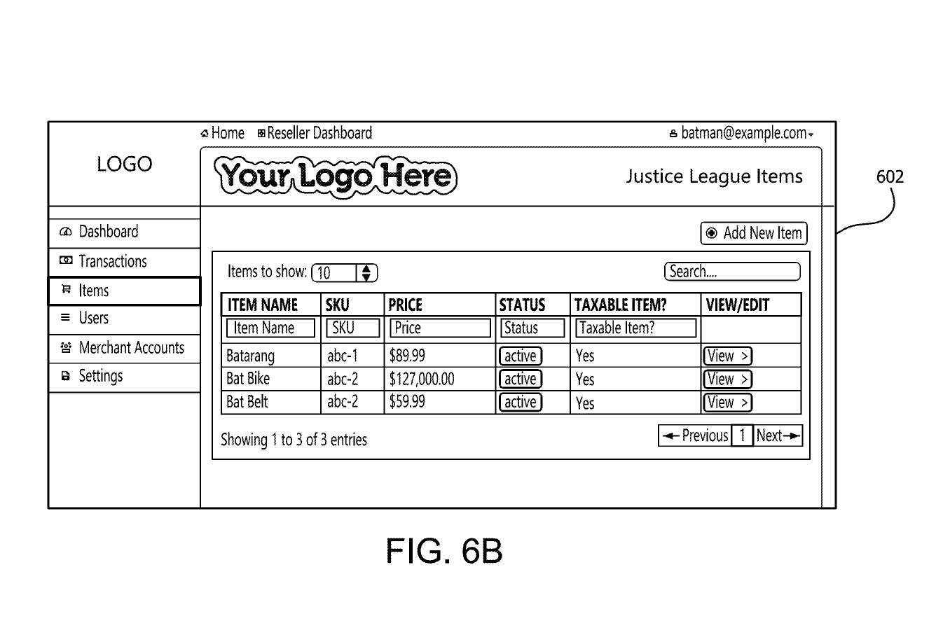

FIGS. 6A-6B show example screenshots of a customized merchant portal. FIG. 6A shows a dashboard screen 601, depicting information relating to the total amount of charges, number of successful charges, and average amount per charge, among other customized information for the example merchant “Justice League”. In addition, the example customized merchant portal depicted in screen 601 includes the reseller logo “Your Logo Here”, as well as the provider logo “Logo”.

FIG. 6B shows an Items screen 602, depicting sales for items sold by the example merchant “Justice League”. In addition, the example customized merchant portal depicted in screen 602 includes the reseller logo “Your Logo Here”, as well as the provider logo “Logo”. Screen 602 also includes a clickable button to add additional sale items.

Utilizing the customized merchant portal, the merchant may perform similar functions as when using the customized mobile application. For example, reporting and analytics may be performed in terms of tracking employees sales/tips and tracking what products are selling the most. Additionally, transaction details may be viewed such as the date, time, amount, signature image, or the like of each transaction. Additionally, receipts may be re-transmitted and transactions may be reversed. The customized merchant portal may be further used to add and manage employees, set employee user permissions, view and edit item level inventory, and import/export items to and from inventory.

The screenshots shown in FIGS. 5A-6B may be transmitted to the printer 125 and printed to provide a hard copy of transactions, receipts, reports and data. For example, a report, such as an annual report, or other compiled report may be generated and stored in the memory 112 of the wireless device 110. Further a report may be emailed, (e.g., as a PDF file) to another device, as well as transmitted to the printer 125 and printed.

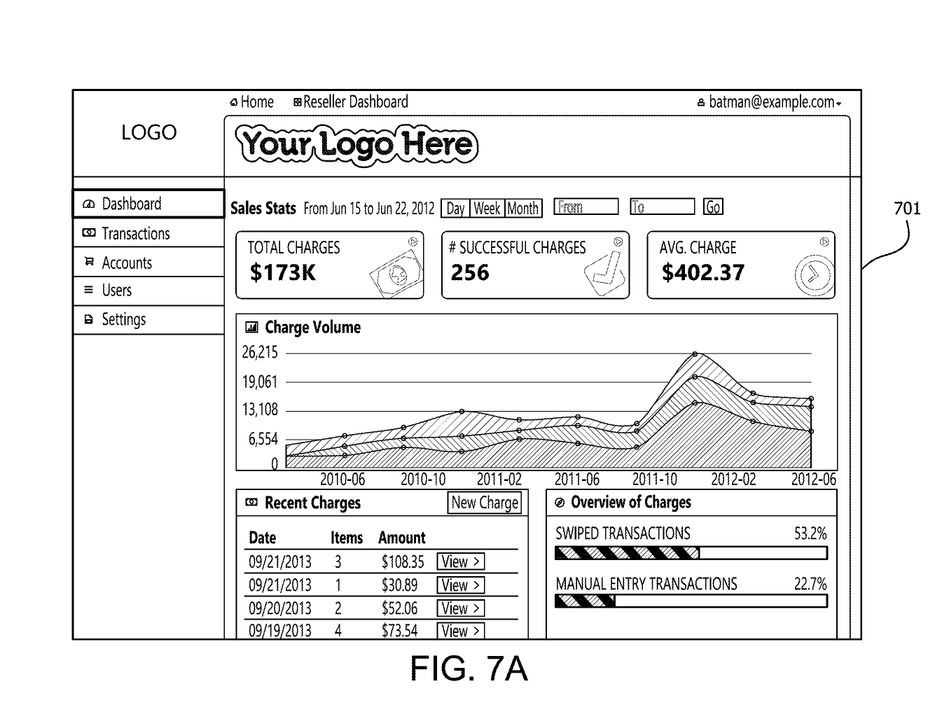

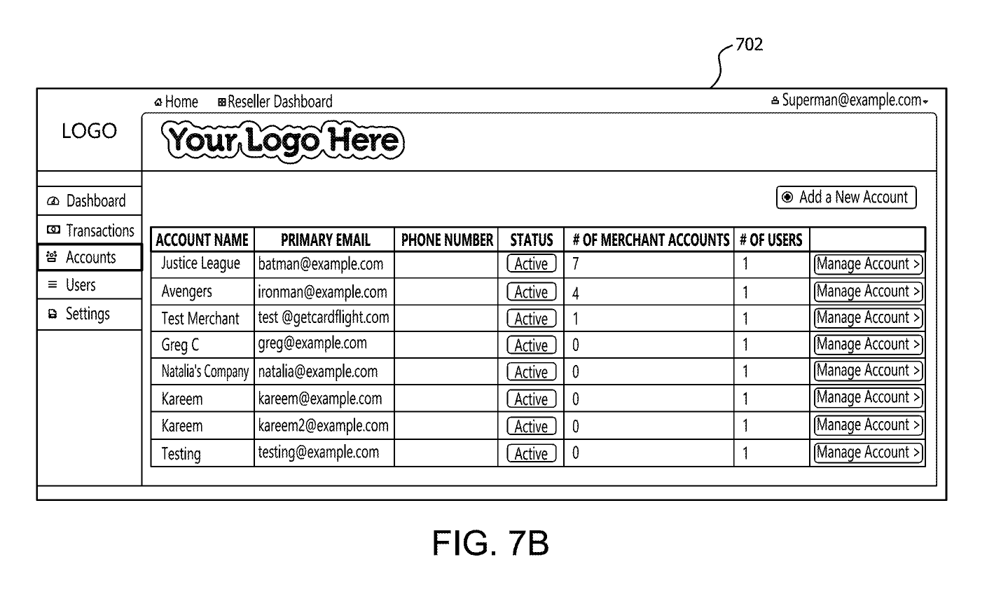

FIGS. 7A-7B show example screenshots of a reseller portal. FIG. 7A shows an example screenshot 701 depicting information relating to the total amount of charges, number of successful charges, and average amount per charge, among other customized information for the example reseller, whose logo “Your Logo Here” is depicted along with the provider logo depicted as “Logo”.

FIG. 7B shows an example screenshot 702 depicting sales information from multiple merchants authorized by the reseller. In addition, the example customized reseller portal depicted in screen 702 includes the reseller logo “Your Logo Here”, as well as the provider logo “Logo”. Screenshot 702 depicts a clickable button to add additional merchants.

Accordingly, via the reseller portal, the reseller may perform various functions such as portfolio and merchant level reporting/analytics, and creating/managing merchant accounts. Additionally, the reseller may provide information in support of merchant accounts, (e.g., password resets), and view/manage transactions among merchants to assist with chargebacks, dispute resolution, reversals, or the like. The reseller may also perform functions such as adding new merchant accounts associated with a merchant, (e.g., for a multi-location merchant), adding/deleting user accounts of a merchant, changing the reseller logo, and changing customized text of the reseller such as contact information.

The screenshots shown in FIGS. 7A-7B may be transmitted to the printer 165 and printed to provide a hard copy of transactions, receipts, reports and data. For example, a report, such as an annual report, or other compiled report may be generated and stored in a memory located in the one or more reseller devices 160. Further a report may be emailed, (e.g., as a PDF file) to another device, as well as transmitted to the printer 165 and printed.

Although features and elements are described above in particular combinations, one of ordinary skill in the art will appreciate that each feature or element can be used alone or in any combination with the other features and elements.

For example, any system may be utilized to accept the transmissions to connect to the Internet, including a wired system. Additionally, although only one wireless device, (i.e., wireless device 110), is shown for the mobile merchant, it should be noted that a merchant may have additional wireless devices with additional merchant accounts that may use a different credit card reader, or the same credit card reader.

The system described above may include a number of aspects. For example, it may include encrypted card readers, payment terminal applications for wireless devices, a merchant web portal, a reseller web portal, and a processor agnostic gateway. In an embodiment, the method and apparatus may provide a turnkey mobile payment solution allowing a reseller to provide a mobile point of sale to merchants with cobranding for the reseller. Additionally, although the system is shown including a swiped card reader for the merchant to conduct sales transactions, it is to be understood that the system could be utilized to accept credit/debit cards utilizing chip technology.

In addition, the merchant may utilize one or more card readers and accounts to operate his or her business. For example, a hair salon might set up an account for each stylist such that each stylist has his or her own sub-account and the merchant can track sales/tips per stylist. Since the method and apparatus are not device-centric, a merchant can make changes, (e.g., to inventory), such that the change is propagated from one device/account to a server and then through to all other devices on the main merchant account. For example, if one employee sells a product, the quantity of that product in stock can be reduced and the reduced number propagated to the devices of all the rest of the employees.

A “demo-mode” may also be provided to resellers and/or merchants, such that they may utilize and learn the application and its functions prior to actually making real-world transactions. This may increase the efficiency of use of the applications.

What is claimed is:

1. A method, implemented in a server, for providing a merchant product, the method comprising:
receiving, by the server via the Internet, a first transmission from a first device, the first transmission including information relating to authentication data for authenticating a second device for which to provide the merchant product;
storing the authentication data in a database of the server;
receiving, by the server via the Internet, a second transmission from the second device, the second transmission including an authentication request to receive the merchant product, the authentication request including data for authenticating the second device;
comparing the information in the second transmission to the authentication data stored in the database of the server to determine whether or not the second device is authenticated;
if the second device is authenticated, the server customizing the merchant product based upon the authentication data stored in the database of the server; and
transmitting the customized merchant product via the Internet to the second device.

2. The method of claim 1 wherein the first device is a reseller device and the second device is a merchant device.

3. The method of claim 2 wherein the first transmission includes data relating to the reseller.

4. The method of claim 3 wherein the data relating to the reseller includes a logo of the reseller.

5. The method of claim 4 wherein the customizing of the merchant product includes incorporating the logo of the reseller onto a screen displayed by the customized merchant product on the second device.

6. The method of claim 1 wherein the second device wirelessly transmits the second transmission to the server via the Internet.

7. The method of claim 1 wherein the second device includes any one of a smartphone or tablet.

8. The method of claim 7 wherein the second device further comprises an electronic card reader configured to read information from a credit card or debit card.

9. An apparatus, comprising:
a processor;
an input/output (I/O) driver; and
a memory;
wherein the processor is configured to receive a first transmission from a first device from the I/O driver via the Internet, the first transmission including information relating to authentication data for authenticating a second device for which to provide the merchant product, store the authentication data in the memory, receive from the I/O driver via the Internet, a second transmission from the second device, the second transmission including an authentication request to receive the merchant product, the authentication request including data for authenticating the second device, compare the information in the second transmission to the authentication data stored in the memory to determine whether or not the second device is authenticated, if the second device is authenticated, customize the merchant product based upon the authentication data stored in the memory, and transmit through the I/O device, the customized merchant product via the Internet to the second device.

10. The apparatus of claim 9, further comprising a database in the memory, wherein the authentication data is stored in the database.

11. The apparatus of claim 10 wherein the first transmission includes data relating to a reseller.

12. The apparatus of claim 11 wherein the data relating to the reseller includes a logo of the reseller.

13. The apparatus of claim 12 wherein the processor is further configured to incorporate the logo of the reseller onto a screen displayed by the customized merchant product on the second device.

14. A system, comprising:
a first device in communication with the Internet, the first device configured to transmit a first transmission via the Internet including information relating to authentication data for authenticating a second device for which to provide a merchant product;
a second device in communication with the Internet, the second device configured to transmit a second transmission via the Internet including an authentication request to receive the merchant product, the authentication request including data for authenticating the second device; and
a server in communication with the Internet, the server configured to receive the first transmission and the second transmission via the Internet, and configured to store the authentication data, compare the information in the second transmission to the authentication data stored to determine whether or not the second device is authenticated, if the second device is authenticated, customize the merchant product based upon the authentication data stored, and transmit the customized merchant product via the Internet to the second device.

15. The system of claim 14 wherein the second device further comprises:
a processor;
a receiver in communication with the processor;
a transmitter in communication with the processor; and
an antenna in communication with the receiver and the transmitter;
wherein the processor controls the transmitter to transmit the second transmission to the server via the antenna, and the processor is configured to receive the transmission of the customized merchant product from the receiver via the antenna.

16. The system of claim 15 wherein the second device further comprises a memory in communication with the processor and the processor stores the customized merchant product in the memory.

17. The system of claim 15 wherein the second device further comprises an input/output (I/O) driver in communication with the processor, the I/O driver configured for connection to an electronic card reader to read information from a credit card or debit card and provide the information to the processor.

18. The system of claim 14 wherein the server further comprises a processor, a memory in communication with the processor, and an input/output (I/O) driver in communication with the processor, wherein the processor receives the first transmission and the second transmission from the I/O driver and stores the authentication data in the memory.

19. The system of claim 18 wherein the server further comprises a database in the memory, the authentication data stored in the database of the memory.

20. The system of claim 18 wherein the processor is further configured to transmit the customized merchant product via the Internet through the I/O device.
